(19) United States
(12) Patent Application Publication
(10) Pub. No.: US 2024/0309695 A1
(43) Pub. Date: Sep. 19, 2024

(54) ANTI-THEFT DEVICE

(71) Applicant: The Secretary of State for Defence, Salisbury, Wiltshire (GB)

(72) Inventor: John Russel Smith, Salisbury (GB)

(21) Appl. No.: 18/550,789

(22) PCT Filed: Mar. 17, 2022
(86) PCT No.: PCT/IB2022/052438

§ 371 Date: Sep. 15, 2023

(30) Foreign Application Priority Data
Mar. 22, 2021 (GB) 2103912.8

(51) Int. Cl. E05G 1/14; G07D 11/125; G07D 11/225

(52) U.S. Cl. CPC E05G 1/14; G07D 11/125; G07D 11/225

(57) ABSTRACT

The invention provides an anti-tamper container for storing, transporting and optionally dispensing a stack of banknotes, in particular an anti-tamper container in the form of an Automated Teller Machine (ATM) cassette or a cash-in-transit box, wherein the container comprises at least one vessel containing a spoiling agent in fluid communication with the stack of banknotes, wherein the spoiling agent is a liquid phase material in a temperature range greater than or equal to 100° C. The invention also provides an associated cash dispenser machine, preferably an ATM, an insert for an anti-tamper container and associated methods and uses.

### TECHNICAL FIELD OF THE INVENTION

The invention is concerned with an anti-tamper container for storing, transporting and optionally dispensing a stack of banknotes, in particular an anti-tamper container in the form of an Automated Teller Machine (ATM) cassette or a cash-in-transit box. In related aspects, the invention is concerned with an associated cash dispenser machine, preferably an ATM, an insert for an anti-tamper container and associated methods and uses.

### BACKGROUND TO THE INVENTION

Self-service cash dispenser systems such as ATMs are subject to robbery by physical tampering, for example by the use of explosives, by so-called ‘ram raids’, or by cutting devices and tools. In order to deter robbery and/or prevent the use of bank notes if stolen, countermeasure systems are known which stain or destroy banknotes.

U.S. Pat. No. 5,537,938 to Lopez discloses an anti-theft device for ATMs which comprises a tank of indelible dye or ink which, upon a breach of security of the ATM, causes the dye or ink to be released via a distribution manifold into the banknote cassette.

U.S. Pat. No. 10,332,359 to Lopez discloses a system for triggering bank equipment bill destruction in which pyrotechnic means are used to trigger bill destruction devices placed inside the cassettes of the bank equipment.

Anti-theft systems also exist which aim to prevent the breach of a container by the introduction of an explosive. For example, U.S. Pat. No. 9,995,079 to Fumanelli discloses a system comprising ignition means designed to ignite any explosive substance inserted into a container, before it reaches critical mass. However, the ignition means does not serve to mark or otherwise degrade the banknotes.

It is an object of the invention to provide alternative or improved countermeasures.

### SUMMARY OF THE INVENTION

According to a first aspect, the invention provides an anti-tamper container for storing, transporting and optionally dispensing a stack of banknotes, the container comprising:
a) a casing having a sealable lid or opening;
b) at least one compartment within the casing for holding the stack of banknotes;
c) at least one vessel containing a spoiling agent in fluid communication with the stack of banknotes;
d) means for heating the spoiling agent; and
e) a first trigger associated with the heating means and the at least one vessel;
   wherein the spoiling agent is a liquid phase material in a temperature range greater than or equal to 100° C., and wherein activation of the first trigger causes the means for heating to heat the spoiling agent to a temperature in the range of greater than or equal to 100° C.

The term ‘banknote’ is not intended to be limiting and includes cash, bills, cheques, banker's drafts and other currency or tender in the forms of sheets or notes. However, the system is particularly suitable for polymer banknotes, in particular banknotes formed from a synthetic polymer such as polypropylene e.g. biaxially oriented polypropylene.

The invention is applicable to containers for storing, transporting and optionally dispensing banknotes. Two common examples are ATM cassettes and cash-in-transit containers.

A typical prior art cash-in-transit box is illustrated in FIG. 1, showing a container (1) for storing and transporting a stack of banknotes (2). Container (1) comprises a casing (3) with an inner volume (4) for storing the stack of banknotes (2), inner volume (4) defined by opposing sides, (5a, 5c and 5b, 5d) with upper edges (6a, 6c and 6d, 6d) upstanding from base (7). Container (1) is connected to a lid (8), shown in an ‘open’ configuration in FIG. 1, via hinges (9a, 9b, 9c). Lid (8) is provided with a sealing mechanism (10) to allow lid (8) to be locked in a ‘closed’ position (not shown) when lid (8) is arranged against upper edges (6a, 6b, 6c, 6d) to cover inner volume (4). The ‘closed’ position prevents unwanted access to banknotes (2) stored within container (1) during transport. Container (1) may be provided with a handle (not shown) to assist a user during manual handling of container (1). Container (1) has compartments (11a, shown without stack of banknotes; 11b, shown with stack of banknotes (2)), each defined by opposing sides (12a, 12c and 12b, 12d; 13a (13b-d not shown) that enable storage of banknotes (2) in a desired orientation during storage and transport.

A typical prior art ATM cassette is illustrated in FIG. 2, showing a container (20) for storing, transporting and dispensing of a stack of banknotes (2). Container (20) comprises a casing (23) with an inner volume (24) for storing the stack of banknotes (2), inner volume (24) defined by opposing sides, (25a, 25c and 25b, 25d) with upper edges (26a, 26c and 26d, 26d) upstanding from base (27). Container (20) is connected to a lid (28), shown in an ‘open’ configuration in FIG. 2, via hinges (29a, 29b, 29c). Lid (28) is provided with a sealing mechanism (30) to allow lid (28) to be locked in a ‘closed’ position (not shown) when lid (28) is arranged against upper edges (26a, 26b, 26c, 26d) to cover inner volume (24). The ‘closed’ position prevents unwanted access to banknotes (2) stored within container (20) during transport. Container (20) may be provided with a handle (not shown) to assist a user during manual handling of container (1). Container (20) has a compartment defined by inner sides (31a, 31b) and a moveable element (32) to retain the stack of banknotes (2) in a desired orientation during storage and transport. Furthermore, the moveable element (32) can provide a force to direct the stack of banknotes towards an opening (not shown), typically provided in base 27 in a region proximal to side (25c), which enables the dispensing of individual banknotes, for example when a monetary withdrawal is initiated by an individual at an ATM. Alternatively, the opening (not shown) is associated with lid (28). Moveable element (32) is raised above base (27) via bars (33a, 33b), ending in runners (34a, 34b) which rest respectively on side edges (35a, 35b). Power to enable moveable element (32) to direct stack of banknotes (2) to an opening for dispensing is provided by power source (36), connected via power cable (37) to the moveable element (32).

In general, prior art systems which deface, degrade or destroy banknotes can be problematic if the technique for defacing, degrading or destroying the banknotes cause the serial numbers of the banknotes to be rendered illegible and hence, ineligible for currency replacement by organisations such as the Bank of England. This can be particularly problematic for techniques based on ignition and/or combustion, or techniques using pervasive glues.

GB 2491409 discloses a dispensing system comprising a first and second container 34, 40 containing respective first and second fluids, means for breaching the containers and means for directing the fluid towards an item such as a stack of bank notes. The first and second fluids provide a multi-component agent, exemplified as a two-part resin or adhesive capable of binding/encasing a stack of banknotes. The fluids may additionally include a visible ink or invisible marking agent. Activating the breaching means, for example via first and second pyrotechnic triggers 36, 42, results in release of the first and second fluids from their respective containers, enabling the two fluids to mix into a form that can subsequently bind/encase, and in certain embodiments mark, the item in question. However, this dispensing system may be associated with the abovementioned problems regarding anti-tamper devices for banknotes i.e. the use of a resins/adhesives may render the serial numbers of the banknotes illegible or inaccessible, while the use of a marking agent may not be compatible with marking polymer banknotes. Furthermore, GB 2491409 discloses a dispensing system that requires two specific fluids to mix in order to achieve its anti-tamper effects.

The anti-tamper container of the invention provides a countermeasure system that advantageously prevents use of the notes by robbers via a spoiling agent for partially degrading the notes, wherein because the spoiling agent is in fluid communication with the stack of banknotes the spoiling agent is dispersed, when heated to a temperature of greater than or equal to 100° C., from the vessel such that it contacts and damages the stack of banknotes. Thus, it is to be understood that at least one vessel contains a spoiling agent that in use (i.e. when heated to a desired temperature of greater than or equal to 100° C.) is capable of fluid communication with the stack of banknotes. For example, the at least one vessel is configured such that the heated spoiling agent can be dispersed from the vessel to contact the stack of banknotes. The damage introduced onto a stack of banknotes by use of the invention includes any type of permanent physical distortion, including a cut, groove, notch, hole, partial degradation or other such imperfection, such as at an edge region of a stack of banknotes, but ideally in a location that may damage each individual banknote in the stack of banknotes. In a preferred embodiment, the banknotes are rapidly and permanently marked or degraded, but the integrity of the serial number is preserved i.e. the spoiling agent is dispensed in a manner that does not fully degrade the notes such that the tender is not replaceable.

Polymer banknotes typically begin to shrink and/or melt at temperatures of approximately 120° C. or greater. As such, the spoiling agent may comprise any suitable substance, formulation or material that is in a liquid phase when heated to a temperature of greater than or equal to 100° C. It is envisaged that the spoiling agent is a liquid that remains in a liquid phase upon heating to greater than or equal to 100° C., or the spoiling agent is a solid that is converted into a liquid upon heating to a temperature of greater than or equal to 100° C.

Preferably, the spoiling agent is a liquid phase material in a temperature range greater than or equal to 110° C., and wherein activation of the first trigger causes the means for heating to heat the spoiling agent to a temperature in the range of greater than or equal to 110° C.

Further preferably, the spoiling agent is a liquid phase material in a temperature range greater than or equal to 120° C., and wherein activation of the first trigger causes the means for heating to heat the spoiling agent to a temperature in the range of greater than or equal to 120° C.

More preferably, the spoiling agent is a liquid phase material in a temperature range 120° C. to 200° C., and wherein activation of the first trigger causes the means for heating to heat the spoiling agent to a temperature in the range of 120° C. to 200° C. For example, the spoiling agent is a liquid phase material at a temperature of 150° C., and wherein activation of the first trigger causes the means for heating to heat the spoiling agent to a temperature of 150° C.

Preferably the upper temperature range is no more than 250° C., even more preferably no more than 200° C.

Prior art materials capable of attacking polypropylene tends to be aggressive in attacking other materials, making it difficult to contain and potentially harmful or even lethal if they escape confinement. Furthermore, while polypropylene is susceptible to heat, in sheet form this material will tend to contract, distort or retreat from the heat stimulus. Unless the hot surface remains in contact with the polypropylene, the damaging potential of the heating surface is limited. In trials conducted by the inventor, damage to banknotes occurred when good physical contact remained between a heated spoiling agent and the polypropylene banknotes.

The spoiling agent may be a natural or synthetic material, or a combination thereof.

The spoiling agent may comprise one or more oils (including organic and inorganic oils, more specifically plant derived, mineral and silicone oils), fats, waxes, thermoplastic adhesives (e.g. polyvinyl chloride, polypropylene, polyvinyl fluoride) including hot-melt adhesives (e.g. ethylene-vinyl acetate copolymers, polyolefins such as polyethylene, polyamides, polyurethanes, polycaprolactone) or alloys (e.g. low melting point metal alloys such as tin-based or bismuth-based alloys).

Preferably, the spoiling agent may comprise one or more oils (including organic and inorganic oils, more specifically plant derived, mineral and silicone oils), fats, waxes or alloys (e.g. low melting point metal alloys such as tin-based or bismuth-based alloys).

More preferably, the spoiling agent may comprise one or more oils (including organic and inorganic oils, more specifically plant derived, mineral and silicone oils), fats or waxes.

Preferably, the spoiling agent is an oil, wax or fat i.e. any predominantly nonpolar chemical spoiling agent that can be derived from, or based on, animal, vegetable or petrochemical matter. Typically, such material(s) can form a viscous liquid at room temperature (for example in the case of oils), or form a solid at room temperature, but convert to a liquid upon heating (for example in the case of fats and waxes). Oils typically have a ‘smoke point’ (or burning point) greater than 100° C., ensuring such spoiling agents would remain in a liquid form while reaching a desired temperature.

More preferably, the spoiling agent comprises an oil. The oil may be a mineral oil, for example any mixture of higher alkanes, such that those derived from a distillate of petroleum, such as paraffin e.g. liquid paraffin, or baby oil.

Alternatively, the oil is an organically-derived oil, for example a plant- or animal-derived oil. Preferably, the oil is a vegetable oil selected from a group consisting of palm, soybean, rapeseed, sunflower seed, peanut, cottonseed, palm kernel, coconut and olive oil. Advantageously, vegetable oils are usually safe to handle, cheap and provide the required physical properties such as temperature range and viscosities.

Most preferably, the spoiling agent is rapeseed oil. Advantageously, the smoke point of refined rapeseed oil is approximately 200° C.

Advantageously, the inventor has shown that use of a relatively non-toxic spoiling agent such as rapeseed oil, heated to a temperature of greater than or equal to 100° C., preferably heated to a temperature of greater than or equal to 110° C., further preferably heated to a temperature of greater than or equal to 120° C., more preferably heated to a temperature in the range 120° C. to 200° C., for example a temperature of 150° C., provides a highly effective spoiling agent to a stack of polypropylene sheets. In use, the heated spoiling agent is capable of ‘wicking up’ between the sheets of polypropylene banknotes upon contact. Thus, with respect to the anti-tamper container of the invention, trials showed that dispersing heated spoiling agent onto the stack of banknotes resulted in permanent physical distortion to the polypropylene sheets. This effect was observed due to the chemical/heating reaction between the heated spoiling agent and the banknotes. It is envisaged that the region of the stack of banknotes that is subjected to the heated spoiling agent is a region that avoids the serial number of the banknotes, for example at an edge region of the stack of banknotes. Indeed, the inventor has demonstrated that dispersing heated spoiling agent, such as rapeseed oil, onto one end of the stack of banknotes away from the region of serial numbers resulted in damage to the banknotes while preserving the integrity of the serial numbers.

As understood by the skilled person, the means for heating the spoiling agent may be any suitable means. Examples of heating means include, but are not limited to: a pyrotechnic means e.g. as per a thermal battery; chemical means such as via the Goldschmidt process associated with materials such as thermite, or other chemical heating means e.g. adding water to sulphuric acid; and/or electrical means such as via an immersion heater. The means for heating the spoiling agent will ensure it reaches the desired temperature (i.e. greater than or equal to 100° C., preferably greater than or equal to 110° C., further preferably greater than or equal to 120° C., more preferably a temperature in the range 120° C. to 200° C., for example 150° C.). The means for heating may be associated with a thermostat to ensure the heating means, and by extension the spoiling agent to be heated, reaches the desired temperature when triggered.

The means for heating the spoiling agent is configured to be connected to, or connectable with, a first trigger. Any suitable trigger may be used i.e. a trigger activated by an environmental cue. One example of a suitable trigger is an electrical signal. The electrical signal may take the form of an electrical trigger pulse. The first trigger is typically activated as a result of tampering or interference with the container being detected, which in turn is typically linked to a change in one or more parameters or physical properties associated with the integrity and/or motion of the anti-tamper container. Example techniques for detecting tampering include (but are not limited to) one or more of the following: detecting explosive gases (for example, from an attempt to open the container using explosives); detecting a change in temperature over time (for example, from an attempt to freeze the container with a cryogen); detecting a change in a light sensor (for example, from an attempt to force open the container); using a shock sensor or a tilt sensor such as an accelerometer; using an under- and/or over-voltage sensor (for example, to detect if the container is deprived of power or subjected to excessive power); and/or using a contact break sensor or a contact make sensor (for example, to detect opening of the container). Depending on the type of trigger used, the first trigger may also provide the means for providing the heat stimulus e.g. if the trigger generates an electrical signal (e.g. an electrical trigger pulse) which facilitates heating the spoiling agent (e.g. via an element such as a heating coil or immersion heater) as a consequence of tampering.

The term “tampering” is not intended merely to cover attempts to damage and/or open the container, and includes the theft or removal of a case or cartridge. Tracking mechanisms can acquire information on theft or removal ahead of any actual tampering, and the first trigger may be activated in response to such information.

When banknotes are stored in a compartment within a casing, this arrangement may result in the banknotes within the stack being compressed together. In case of an ATM cassette, for example, banknotes are held together in a compressed arrangement. When a user initiates the process to withdraw money, an internal mechanism can remove the desired number of banknotes for the stack and enable their external delivery from the compartment to the user. To ensure that the banknotes feed reliably, pressure is exerted on the opposing end of the banknotes stack, relative to the end from which banknotes are removed, by a plate driven by an electric motor. However, arranging the banknotes in a compressed stack may act to protect the inner sheets from potential damage by a spoiling agent. Therefore, following activation of the first trigger, it is preferable that the sheets are not compressed too tightly, to allow the heated spoiling agent, when dispersed, to contact all the banknotes in the stack (including the inner banknotes of the stack). Therefore, preferably the at least one compartment within the casing for holding the stack of banknotes comprises an urging means, acting on the stack of banknotes, that can be relaxed and/or tightened in the event that the means for heating the spoiling agent is triggered. The purpose of providing an urging means which can be relaxed and/or tightened is to loosen the stack of banknotes so that the flow of the spoiling agent around and/or between the banknotes is enhanced. The urging means may be relaxed and/or tightened to loosen whole or part of the stack of banknotes. For example, the urging means comprises at least one driver plate connected to an electric motor, the at least one driver plate configured to preferentially compress the stack of banknotes. Triggering the means for heating the spoiling agent, via the first trigger, would also activate the electric motor to reduce (i.e. relax) the pressure provided by the at least one driver plate on the stack of banknotes to loosen the stack of banknotes. The urging means may alternatively be tightened at a region of the stack of banknotes such that an opposing region of the stack of banknotes is comparatively loosened e.g. in a fanning-out manner. The urging means may act on opposing regions of a stack of banknotes, wherein triggering the means for heating the spoiling agent, via the first trigger, results in the urging means: tightening at a region of the stack of banknotes; and relaxing at an opposing region of the stack of banknotes, such that the stack of banknotes is comparatively loosened at the opposing region. These configurations provide the advantage of loosening the stack of banknotes, for example at a desired region of the stack of banknotes, upon detection of a tampering event, allowing the heated spoiling agent when dispersed to wick up between the loosened banknotes, thus increasing the susceptibility of the banknotes within the stack to the heated spoiling agent.

The invention comprises at least one vessel arranged in fluid communication with the stack of banknotes i.e. the at least one vessel is configured such that the heated spoiling agent can be dispersed from the vessel to contact the stack of banknotes.

Preferably, the at least one vessel is capable of degradation upon heating of the spoiling agent to greater than or equal to 100° C. Thus, the at least one vessel could be formed from a material that melts following heating of the spoiling agent to 100° C. or greater. For example, the vessel is made from polypropylene i.e. the same material as the polymer banknotes. Using a material that inherently degrades at a temperature comparable to that at which banknotes suffer damage offers the advantage of the anti-tamper container not requiring an additional sensor or mechanism to effect the release of the spoiling agent, upon being heated to 100° C. or greater, from the at least one vessel.

Further preferably, the at least one vessel is capable of degradation upon heating of the spoiling agent to greater than or equal to 110° C. More preferably, the at least one vessel is capable of degradation upon heating of the spoiling agent to greater than or equal to 120° C. Most preferably, the at least one vessel is capable of degradation upon heating of the spoiling agent to a temperature in the range 120° C. to 200° C., for example 150° C.

Alternatively, the anti-tamper container comprises a means for dispersing the heated spoiling agent. The means for dispersing the heated spoiling agent may comprise an element capable of rupturing the at least one vessel. Such means may include any suitable means for cutting, piercing or damaging the at least one vessel, for example a wire saw, spike or abrasive surface that can be initiated to contact the at least one vessel. The means for rupturing may be an additional heating element, arranged to contact, and form a hole in, the at least one vessel. Such arrangements offer the advantages of a simple and rapid means for dispersing the heated spoiling agent. Alternatively, the at least one vessel comprises an element, or arrangement of elements, capable of directing the heated spoiling agent onto the stack of banknotes. Preferably, the element, or arrangement of elements, comprises at least one printer nozzle. Further preferably, the element, or arrangement of elements, comprises at least one 3-D printer heating nozzle. Alternatively, the element, or arrangement of elements, comprises at least one pipe and at least one piston arrangement, wherein the at least one piston is actuated by a mechanical or pneumatic means. However, it is to be understood that, where required, the element for dispersing the heated spoiling agent is associated with other elements as required to e.g. funnel, power and/or facilitate the transport of the heated spoiling agent during the dispersal process. Such arrangements offer the advantage of ensuring the heated spoiling agent is directed from the at least one vessel onto a specific region of the stack of banknotes, in particular a region of the stack of banknotes away from the location of the banknote serial numbers.

The anti-tamper container may comprises an additional or alternative means for rupturing the at least one vessel and/or dispersing the heated spoiling agent as understood by the skilled person.

It is to be understood that the means for dispersing the heated spoiling agent may be triggered by the first trigger. For example, there may be a timer element to ensure the heated spoiling agent is dispersed from the at least one vessel after a period of time allowing the heated spoiling agent to reach a temperature of greater than or equal to 100° C. (preferably greater than or equal to 110° C., further preferably greater than or equal to 120° C., more preferably a temperature in the range 120° C. to 200° C., for example 150° C.). Alternatively, the means for dispersing the heated spoiling agent is triggered by a second trigger. Preferably, the second trigger is a thermostat such as a temperature sensor. This arrangement ensures that the means for dispersing the heated spoiling agent is activated upon the heated spoiling agent reaching a temperature of greater than or equal to 100° C. (preferably greater than or equal to 110° C., further preferably greater than or equal to 120° C., more preferably a temperature in the range 120° C. to 200° C., for example 150° C.), offering the advantage of only releasing the spoiling agent when it is capable of damaging a stack of banknotes. In the event that the at least one compartment within the casing for holding the stack of banknotes comprises an urging means acting on the stack of stack of banknotes, the urging means may be triggered by the second trigger (rather than the first trigger).

It may be envisaged that if a power source is required for the means for heating the spoiling agent, and/or the first/second trigger, this could be provided by an already available power source. For example, an ATM may be provided with its own power source, or draw upon an existing mains supply, which could also be accessed by the heating means and/or first/second trigger.

Preferably, a power source is provide by a dedicated power source capable of being stored within, or associated with, the container. For example, the dedicated power source may be a 9V battery or 24V battery, which may be small enough to reside in, or be associated with, the container. The provision of a dedicated power source would ensure that the anti-theft device will still work, in particular if tampering results in damage to any wider power source associated with the container e.g. damage to an ATM.

Preferably, the container further comprises an audio and/or visual indicator adapted to provide an alert that the means for heating the spoiling agent has been triggered. The audio and/or visual indicator may be triggered by the first/second trigger. Alternatively, the audio and/or visual indicator may be triggered by detecting a physical property associated with the heating of the spoiling agent.

Preferably, the container is an Automated Teller Machine (ATM) cassette and the casing and compartment are adapted to dispense individual banknotes. A typical ATM cassette comprises one compartment for a stack of banknotes. Hence, an ATM cassette in accordance with the invention typically also comprises: at least one vessel containing a spoiling agent in fluid communication with the stack of banknotes; means for heating the spoiling agent; and a first trigger associated with the heating means and the at least one vessel. It is to be understood that the at least one vessel would be arranged in such a manner to ensure that when the spoiling agent is contained in an unheated form within the vessel, this does not prevent dispersing of individual banknotes from an ATM.

Alternatively, the container is a cash-in-transit box, such as a secure suitcase adapted for the manual carriage of banknotes. A cash-in-transit box may comprise a plurality of compartments and hence, a cash-in-transit box in accordance with the invention typically comprises: at least one vessel containing a spoiling agent in fluid communication with the stack of banknotes; means for heating the spoiling agent; and a first trigger associated with the heating means and the at least one vessel.

According to a second aspect, the invention provides a cash dispenser machine comprising an anti-tamper container according the first aspect, preferably an ATM.

According to a third aspect, the invention provides an insert for an anti-tamper container for storing, transporting and optionally dispensing a stack of banknotes, the insert comprising a frame locatable within the container, the frame comprising:
a) at least one vessel containing a spoiling agent in fluid communication with the stack of banknotes notes;
b) means for heating the spoiling agent; and
c) a first trigger associated with the heating means and the at least one vessel;
   wherein the spoiling agent is a liquid phase material in a temperature range greater than or equal to 100° C., and wherein activation of the first trigger causes the means for heating to heat the spoiling agent to a temperature in the range of greater than or equal to 100° C.

The insert for an anti-tamper container provides a means for retrofitting an existing container, in particular retrofitting an existing ATM cassette or a cash-in-transit box, to provide a countermeasure system that advantageously prevents use of the notes by robbers via a spoiling agent for partially degrading the notes, wherein the spoiling agent is dispersed, when heated to a temperature of greater than or equal to 100° C., from the vessel such that it contacts and damages the stack of banknotes.

Preferably, the spoiling agent is a liquid phase material in a temperature range greater than or equal to 110° C., and wherein activation of the first trigger causes the means for heating to heat the spoiling agent to a temperature in the range of greater than or equal to 110° C.

Further preferably, the spoiling agent is a liquid phase material in a temperature range greater than or equal to 120° C., and wherein activation of the first trigger causes the means for heating to heat the spoiling agent to a temperature in the range of greater than or equal to 120° C.

More preferably, the spoiling agent is a liquid phase material in a temperature range 120° C. to 200° C., and wherein activation of the first trigger causes the means for heating to heat the spoiling agent to a temperature in the range of 120° C. to 200° C. For example, the spoiling agent is a liquid phase material at a temperature of 150° C., and wherein activation of the first trigger causes the means for heating to heat the spoiling agent to a temperature of 150° C.

Preferably the upper temperature range is no more than 250° C., even more preferably no more than 200° C.

To retrofit an existing container, the insert preferably comprises an urging means, acting on the stack of banknotes, that can be relaxed and/or tightened in the event that the means for heating the spoiling agent is triggered. Thus, when the heated spoiling agent reaches a temperature of greater than or equal to 100° C. and is dispersed, the loosening of the stack of banknotes as described above, upon detection of a tampering event, allows the heated spoiling agent when dispersed to wick up between the loosened banknotes, increasing the susceptibility of the banknotes within the stack to the heated spoiling agent.

According to a fourth aspect, the invention provides a method of safeguarding a stack of banknotes, the method comprising the steps of:
a) placing a stack of banknotes in the anti-tamper container according to the first aspect, the cash dispenser machine according to the second aspect, or an anti-tamper container comprising the insert of the third aspect;
b) in the event of tampering, activation of the first trigger results in the means for heating to heat the spoiling agent to a temperature of greater than or equal to 100° C.; and
c) when the heated spoiling agent reaches a temperature of greater than or equal to 100° C., it is dispersed from the vessel such that it damages the stack of banknotes.

Undertaking the method of the fourth aspect may also prevent or restrict the removal of the stack of banknotes from the container.

Preferably, the spoiling agent is a liquid phase material in a temperature range greater than or equal to 110° C., and wherein activation of the first trigger causes the means for heating to heat the spoiling agent to a temperature in the range of greater than or equal to 110° C.

Further preferably, the spoiling agent is a liquid phase material in a temperature range greater than or equal to 120° C., and wherein activation of the first trigger causes the means for heating to heat the spoiling agent to a temperature in the range of greater than or equal to 120° C.

More preferably, the spoiling agent is a liquid phase material in a temperature range 120° C. to 200° C., and wherein activation of the first trigger causes the means for heating to heat the spoiling agent to a temperature in the range of 120° C. to 200° C. For example, the spoiling agent is a liquid phase material at a temperature of 150° C., and wherein activation of the first trigger causes the means for heating to heat the spoiling agent to a temperature of 150° C.

Preferably the upper temperature range is no more than 250° C., even more preferably no more than 200° C.

Preferably, the method further comprises the step of an urging means, acting on the stack of banknotes, is relaxed and/or tightened in the event that the means for heating the spoiling agent is triggered. Thus, when the heated spoiling agent reaches a temperature of greater than or equal to 100° C. and is dispersed, the loosening of the stack of banknotes as described above, upon detection of a tampering event, allows the heated spoiling agent when dispersed to wick up between the loosened banknotes, increasing the susceptibility of the banknotes within the stack to the heated spoiling agent.

According to a fifth aspect, the invention provides the use of a spoiling agent which is a liquid phase material in a temperature range greater than or equal to 100° C., to contact and subsequently damage a stack of banknotes.

Preferably, the spoiling agent is a liquid phase material in a temperature range greater than or equal to 110° C. Further preferably, the spoiling agent is a liquid phase material in a temperature range greater than or equal to 120° C. More preferably, the spoiling agent is a liquid phase material in a temperature range 120° C. to 200° C. For example, the spoiling agent is a liquid phase material at a temperature of 150° C.

Preferably the upper temperature range is no more than 250° C., even more preferably no more than 200° C.

The spoiling agent may be a natural or synthetic material, or a combination thereof. The spoiling agent may comprise one or more oils (including organic and inorganic oils, more specifically plant derived, mineral and silicone oils), fats, waxes, thermoplastic adhesives (e.g. polyvinyl chloride, polypropylene, polyvinyl fluoride) including hot-melt adhesives (e.g. ethylene-vinyl acetate copolymers, polyolefins such as polyethylene, polyamides, polyurethanes, polycaprolactone) or alloys (e.g. low melting point metal alloys such as tin-based or bismuth-based alloys).

Preferably, the spoiling agent may comprise one or more oils (including organic and inorganic oils, more specifically plant derived, mineral and silicone oils), fats, waxes or alloys (e.g. low melting point metal alloys such as tin-based or bismuth-based alloys).

More preferably, the spoiling agent may comprise one or more oils (including organic and inorganic oils, more specifically plant derived, mineral and silicone oils), fats or waxes.

Preferably, the spoiling agent is an oil, wax or fat i.e. any predominantly nonpolar chemical spoiling agent that can be derived from, or based on, animal, vegetable or petrochemical matter. Typically, such material(s) can form a viscous liquid at room temperature (for example in the case of oils), or form a solid at room temperature, but convert to a liquid upon heating (for example in the case of fats and waxes).

More preferably, the spoiling agent comprises an oil. The oil may be a mineral oil, for example any mixture of higher alkanes, such that those derived from a distillate of petroleum, such as paraffin e.g. liquid paraffin, or baby oil.

Alternatively, the oil is an organically-derived oil, for example a plant- or animal-derived oil. Preferably, the oil is a vegetable oil selected from a group consisting of palm, soybean, rapeseed, sunflower seed, peanut, cottonseed, palm kernel, coconut and olive oil.

Most preferably, the spoiling agent is rapeseed oil

According to a sixth aspect, the invention provides an anti-tamper cassette, cash dispenser machine, insert, method or use substantially as described herein, with reference to the accompanying drawings.

The invention also extends to a precursor anti-tamper container for storing, transporting and optionally dispensing banknotes, the container comprising: a) a casing having a sealable lid or opening; b) at least one compartment within the casing for holding the stack of banknotes; and c) at least one receptacle for receiving: at least one vessel containing a spoiling agent in fluid communication with the stack of banknotes notes, said vessel containing a spoiling agent which is a liquid phase material in a temperature range greater than or equal to 100° C.; a means for heating the spoiling agent; and a first trigger associated with the heating means and the at least one vessel; wherein the at least one receptacle is positioned relative to the at least one compartment such that when the receptacle holds the at least one vessel, the spoiling agent can be heated and dispersed (in accordance with the invention), resulting in the heated spoiling agent contacting, and subsequently damaging, the stack of banknotes. The at least one vessel, spoiling agent and means for heating the spoiling agent may be provide via the insert arrangement as described above.

The invention further extends to a kit, for example a kit comprising the precursor anti-tamper container and the insert of the invention.

The invention is concerned with an anti-tamper container for storing and transporting a stack of banknotes, in particular an anti-tamper container in the form of an Automated Teller Machine (ATM) cassette or a cash-in-transit box. In related aspects, the invention is concerned with an associated cash dispenser machine, preferably an ATM, an insert for an anti-tamper container and associated methods and uses.

Any feature in one aspect of the invention may be applied to any other aspects of the invention, in any appropriate combination. In particular, container aspects may be applied to the insert, method and use aspects and vice versa. The invention extends to a system or method substantially as herein described, with reference to the accompanying drawings.

### BRIEF DESCRIPTION OF THE DRAWINGS

The invention will now be described, purely by way of example, with reference to the accompanying drawings, in which:

FIG. 1 shows a schematic example of a prior art cash-in-transit box;

FIG. 2 shows a schematic example of a prior art ATM cassette;

FIG. 3 shows a schematic representation of a loaded cash-in-transit box according to one preferred embodiment of the invention;

FIG. 4 shows a schematic representation of a loaded ATM cassette according to one preferred embodiment of the invention; and

FIG. 5 shows a schematic representation of a loaded cash-in-transit box according to one preferred embodiment of the invention.

The drawings are for illustrative purposes only and are not to scale.

### DETAILED DESCRIPTION

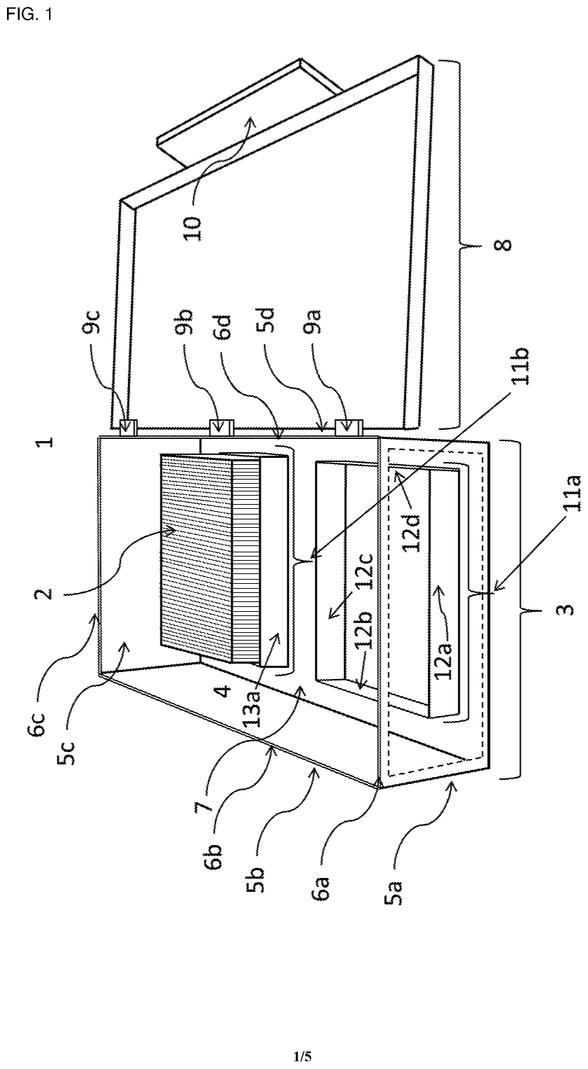

FIG. 1 shows a typical prior art cash-in-transit box as described above.

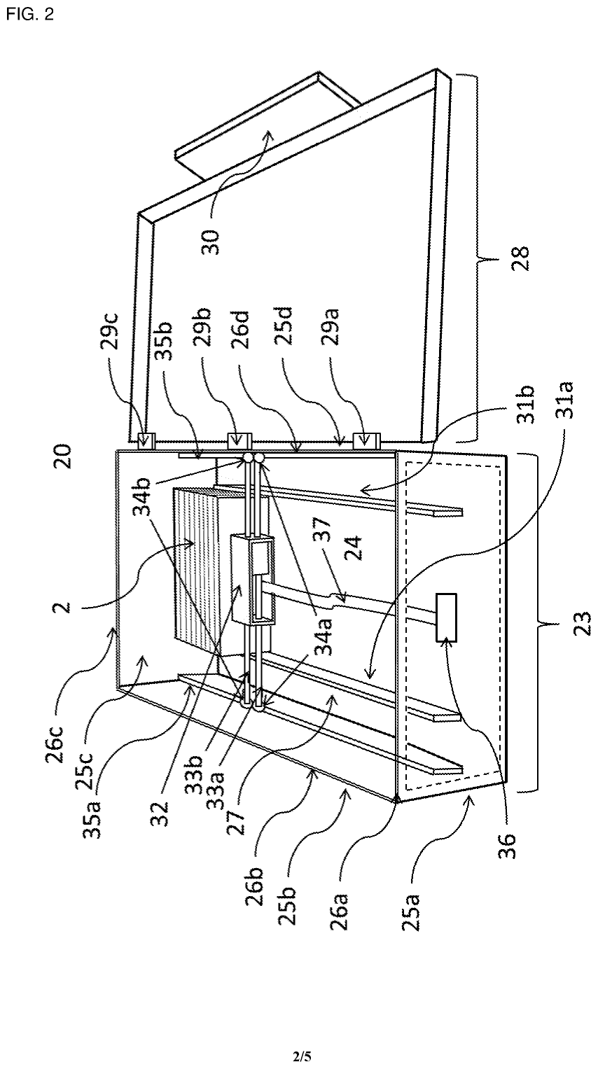

FIG. 2 shows a typical prior art ATM cassette as described above.

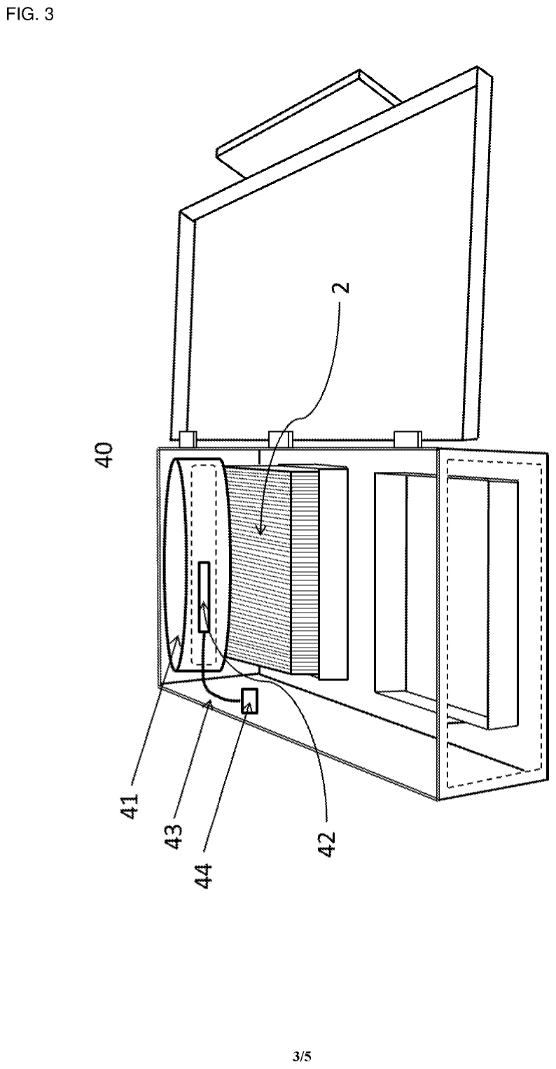

FIG. 3 shows a loaded cash-in-transit box (40) according to one preferred embodiment of the invention. Cash-in-transit box (40) is part-loaded with a stack of banknotes (2) and includes the features described for the prior art cash-in-transit box (1) disclosed in FIG. 1. However, cash-in-transit box (40) comprises a vessel in the form of bag (41) (shown with a part-cutaway region), arranged in close proximity to the stack of banknotes (2). Bag (41) is made of thin plastic and contains rapeseed oil (not shown). Inside bag (41) is a heating coil (42), connected via wire (43) to circuit (44) which can initiate (i.e. power) a current being provided to the heating coil (42). Circuit (44) is also connected to a first trigger (not shown) to ensure that the heating coil (42) heats, upon activation of the first trigger, which in turn heats the rapeseed oil contained in bag (41).

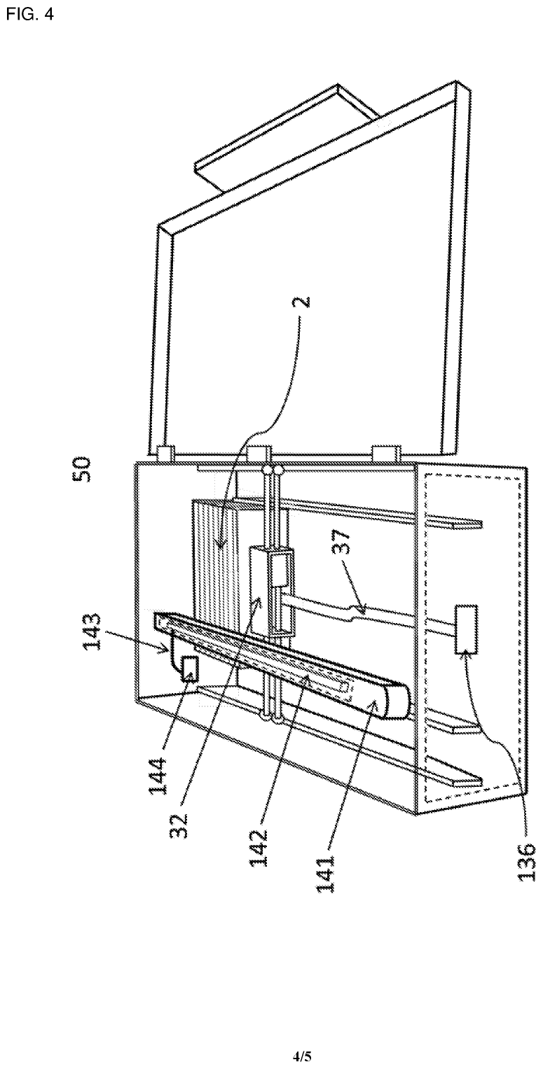

FIG. 4 shows a loaded ATM cassette (50) according to one preferred embodiment of the invention. ATM cassette (50) is part-loaded with a stack of banknotes (2) and includes the features described for the prior art ATM cassette (20) disclosed in FIG. 2. However, ATM cassette (50) comprises a vessel in the form of bag (141) (shown with a part-cutaway-region), arranged in close proximity to the stack of banknotes (2). Bag (141) is made of thin plastic and contains rapeseed oil (not shown). Inside bag (141) is a heating coil (142), connected via wire (143) to circuit (144) which can initiate (i.e. power) a current being provided to the heating coil (142). Circuit (144) is also connected to a first trigger (not shown) to ensure that the heating coil (142) heats, upon activation of the first trigger, which in turn heats the rapeseed oil contained in bag (141). Also shown in ATM cassette (50) is a moveable element (32) to retain the stack of banknotes (2) in a desired orientation during storage and transport. Moveable element (32) can provide a force to direct the stack of banknotes towards an opening (not shown) which enables the dispensing of individual banknotes, for example when a monetary withdrawal is initiated by an individual at an ATM. Power to enable moveable element (32) to direct stack of banknotes (2) to an opening for dispensing is provided by power source (136), connected via power cable (37) to the moveable element (32). Power source (136) is also connected to a first trigger (not shown)

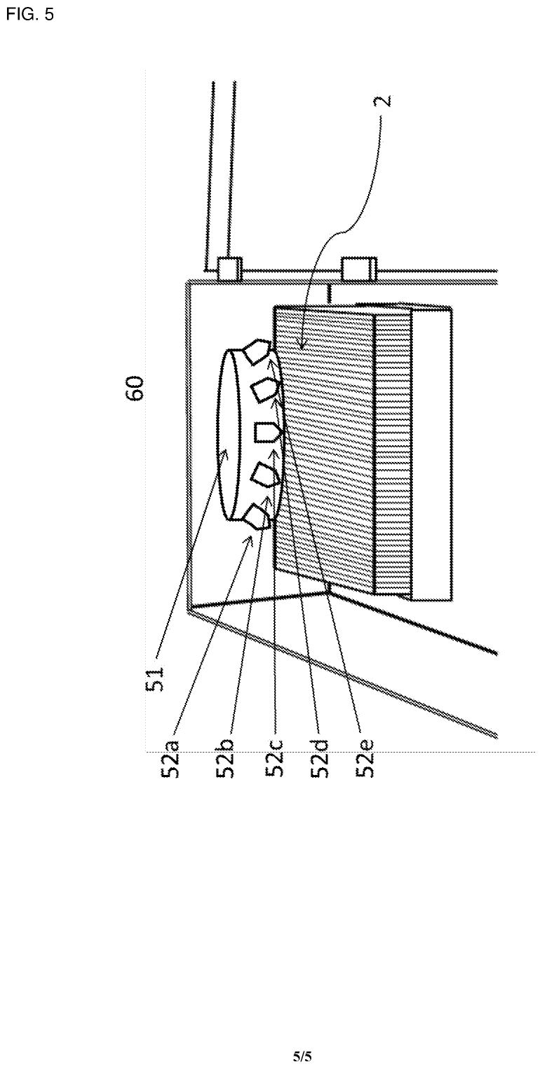

FIG. 5 shows a loaded cash-in-transit box (60) according to one preferred embodiment of the invention. Cash-in-transit box (60) is part-loaded with a stack of banknotes (2) and includes the features described for the prior art cash-in-transit box (1) disclosed in FIG. 1. However, cash-in-transit box (60) comprises a vessel in form of housing (51), arranged in close proximity to the stack of banknotes (2). Housing (51) contains rapeseed oil (not shown). On the outer surface of housing (51) are an arrangement of printer nozzles (52a-e). Associated with/located within housing (51) are a temperature sensor, heater, first and second trigger mechanism and additional spoiling agent dispersal elements (not shown) that work in conjunction with printer nozzles (52a-e). Printer nozzles (52a-e) are capable of directing the heated spoiling agent onto the stack of banknotes (2). It is to be understood that the arrangement shown in FIG. 5 could equally be adapted to the loaded ATM cassette (20) of FIG. 2.

Thus, with reference to FIG. 3 and FIG. 4, in use, a robber activating a trigger (not shown) associated with cash-in-transit box (40) or ATM cassette (50) would result in a current passing through, and heating very quickly, heating coil (42, 142) inside bag (41, 141). In turn, the rapeseed oil inside bag (41, 141) heats to a desired temperature of 150° C. This heating melts bag (41, 141), resulting in the heated rapeseed oil being dispersed over a side region of the stack of banknotes (2). The stack of banknotes (2) are rendered unusable due to damage, while ensuring the banknote serial number is still preserved. In the case of ATM cassette (50), the pressure exerted by moveable element (32) relaxes (e.g. via the action of an electric motor; not shown) upon activation of the first trigger. This relaxation loosens the stack of banknotes (2), allowing the heated rapeseed oil to more effectively wick up between the loosened stack of banknotes (2), increasing the susceptibility of the stack of banknotes (2) to the heated rapeseed oil.

With reference to FIG. 5, in use, a robber activating a first trigger (not shown) associated with cash-in-transit box (60) would result in heating of rapeseed oil inside housing (51), via the heater (not shown), to a desired temperature of 150° C. Upon reaching this temperature, the temperature sensor activates the second trigger mechanism to enable the spoiling agent dispersal elements within housing (51) to transport the heated rapeseed oil to printer nozzles (52a-e) for dispersing over a side region of the stack of banknotes (2). The stack of banknotes (2) are rendered unusable due to damage, while ensuring the banknote serial number is still preserved.

It will be understood that the present invention has been described above purely by way of example, and modification of detail can be made within the scope of the invention. For example, although the invention is used in particular with polymer banknotes, other suitable form of tender or (financial) documentation may be used in an anti-tamper manner by the invention. Each feature disclosed in the description, and (where appropriate) the claims and drawings may be provided independently or in any appropriate combination.

Moreover, the invention has been described with specific reference to anti-tamper and anti-theft systems for containers such as cash-in-transit boxes and ATM cassettes. It will be understood that this is not intended to be limiting and the invention may be used more generally. For example, the invention may be used more generally in the security, banking and finance fields, and may be used to secure objects other than banknotes and other currency. Additional applications of the invention will occur to the skilled person.

1. An anti-tamper container for storing, transporting and optionally dispensing a stack of banknotes, the container comprising:
a. a casing having a sealable lid or opening;
b. at least one compartment within the casing for holding the stack of banknotes;
c. at least one vessel containing a spoiling agent in fluid communication with the stack of banknotes;
d. means for heating the spoiling agent; and
e. a first trigger associated with the means for heating and the at least one vessel;
wherein the spoiling agent is a liquid phase material in a temperature range greater than or equal to 100° C., and wherein activation of the first trigger causes the means for heating to heat the spoiling agent to a temperature in a range of greater than or equal to 100° C.

2. The anti-tamper container according to claim 1, wherein the spoiling agent is a liquid phase material in a temperature range greater than or equal to 110° C., and wherein activation of the first trigger causes the means for heating to heat the spoiling agent to a temperature in a range of greater than or equal to 110° C.

3. The anti-tamper container according to claim 1, wherein the spoiling agent is a liquid phase material in a temperature range greater than or equal to 120° C., and wherein activation of the first trigger causes the means for heating to heat the spoiling agent to a temperature in a range of greater than or equal to 120° C.

4. The anti-tamper container according to claim 1, wherein the spoiling agent is a liquid phase material in a temperature range 120° C. to 200° C., and wherein activation of the first trigger causes the means for heating to heat the spoiling agent to a temperature in a range of 120° C. to 200° C.

5. The anti-tamper container according to claim 1, wherein the spoiling agent comprises a natural or synthetic material, or a combination thereof.

6. The anti-tamper container according to claim 5, wherein the spoiling agent comprises one or more oils, fats, waxes, thermoplastic adhesives or alloys.

7. The anti-tamper container according to claim 6, wherein the spoiling agent comprises one or more oils, fats, waxes or alloys.

8. The anti-tamper container according to claim 7, wherein the spoiling agent comprises one or more oils, fats or waxes.

9. The anti-tamper container according to claim 8, wherein the spoiling agent comprises an organic oil or mineral oil.

10. The anti-tamper container according to claim 9, wherein the mineral oil is a vegetable oil.

11. The anti-tamper container according to claim 10, wherein the vegetable oil is selected from a group consisting of palm, soybean, rapeseed, sunflower seed, peanut, cottonseed, palm kernel, coconut and olive oil.

12. The anti-tamper container according to claim 11, wherein the spoiling agent is rapeseed oil.

13. The anti-tamper container according to claim 1, wherein the at least one compartment comprises an urging means, acting on the stack of banknotes, that can be relaxed and/or tightened upon activation of the first trigger.

14. The anti-tamper container according to claim 1, wherein the at least one vessel is capable of degradation upon heating of the spoiling agent to greater than or equal to 100° C.

15. The anti-tamper container according to claim 14, comprising a means for dispersing the heated spoiling agent.

16. The anti-tamper container according to claim 15, wherein means for dispersing comprises an element capable of rupturing the at least one vessel.

17. The anti-tamper container according to claim 15, wherein the means for dispersing comprises an element, or arrangement of elements, capable of directing the heated spoiling agent onto the stack of banknotes.

18. The anti-tamper container according to claim 15, wherein the means for dispersing the heated spoiling agent is triggered via a second trigger.

19. The anti-tamper container according to claim 1, wherein the container further comprises a dedicated power source capable of being stored within, or associated with, the container.

20. The anti-tamper container according to claim 1, wherein the container further comprises an audio and/or visual indicator adapted to provide an alert that the first trigger has been activated.

21. The anti-tamper container according to claim 1, wherein the container is an Automated Teller Machine (ATM) cassette and the casing and compartment are adapted to dispense individual banknotes.

22. The anti-tamper container according to claim 1, wherein the container is a cash-in-transit box.

23. A cash dispenser machine comprising the anti-tamper container according to claim 21, preferably an ATM.

24. An insert for an anti-tamper container for storing, transporting and optionally dispensing a stack of banknotes, the insert comprising a frame locatable within the container, the frame comprising:
a. at least one vessel containing a spoiling agent in fluid communication with the stack of banknotes;
b. means for heating the spoiling agent; and
c. a first trigger associated with the means for heating and the at least one vessel;
wherein the spoiling agent is a liquid phase material in a temperature range greater than or equal to 100° C., and wherein activation of the first trigger causes the means for heating to heat the spoiling agent to a temperature in a range of greater than or equal to 100° C.

25. A method of safeguarding a stack of banknotes, the method comprising the steps of:
a. placing a stack of banknotes in the anti-tamper container according to claim 1, the anti-tamper container of claim 1;
b. in the event of tampering, activation of the first trigger results in the means for heating to heat the spoiling agent to a temperature in a range of greater than or equal to 100° C.; and
c. when the heated spoiling agent reaches a temperature of greater than or equal to 100° C., it is dispersed from the vessel such that it damages the stack of banknotes.

26. A method of using a spoiling agent which is a liquid phase material in a temperature range greater than or equal to 100° C., to contact and subsequently damage a stack of banknote.

27. The method of using the spoiling agent according to claim 26, wherein the spoiling agent comprises one or more oils, fats, waxes, thermoplastic adhesives or alloys.

28. The method of using the spoiling agent according to claim 27, wherein the spoiling agent is a vegetable oil selected from a group consisting of palm, soybean, rapeseed, sunflower seed, peanut, cottonseed, palm kernel, coconut and olive oil.

29. The method of using the spoiling agent according to claim 28, wherein the spoiling agent is rapeseed oil.

30. (canceled)
